(19) United States
(12) Patent Application Publication
(10) Pub. No.: US 2014/0138468 A1
(43) Pub. Date: May 22, 2014

(54) COOLED GRINDER HEAD

(71) Applicant: Blue Sky Innovation Group, Inc., North Ridgeville, OH (US)

(72) Inventor: Jeffrey W. Palese, North Ridgeville, OH (US)

(73) Assignee: Blue Sky Innovation Group, Inc., North Ridgeville, OH (US)

(21) Appl. No.: 14/086,098

(22) Filed: Nov. 21, 2013

Related U.S. Application Data
(60) Provisional application No. 61/728,926, filed on Nov. 21, 2012.

(51) Int. Cl. A47J 43/07

(52) U.S. Cl. CPC A47J 43/07
USPC 241/285.1

(57) ABSTRACT

An apparatus for grinding food products includes a housing including an inlet for receiving food products to be ground, an outlet for discharging the ground food product, and a grinding portion for housing components operable to grind the food product. The apparatus also includes a chamber for containing a coolant for cooling the grinding portion.

### RELATED APPLICATIONS

This application claims the benefit of U.S. Provisional Application Ser. No. 61/728,926, filed on Nov. 21, 2012, which is hereby incorporated by reference in its entirety.

### TECHNICAL FIELD

This invention relates to a food processing apparatus. More specifically, this invention relates to a cooled grinder head adapted to receive a coolant that helps maintain the head in a cooled condition during use.

### BACKGROUND OF THE INVENTION

Grinders are food processing appliances that are used to grind, chop or mince food products, such as meat, fish, poultry, vegetables, or similar foods. The most common food products processed in a grinder are meat products, such as beef, pork, venison, etc. A known food processing apparatus in the form of a meat grinder 10 is illustrated in FIG. 1. The meat grinder 10 includes a grinder head 12 and a power source 14, such as an electric motor. The electric motor power source could be replaced with a hand crank. The grinder head 12 includes an inlet or chute 16, into which raw meat is fed, and an outlet 18 from which the ground or minced meat is discharged. The grinder head 12 includes a housing 20 that houses typical grinder components, such as an auger/screw conveyor, a rotating knife including mincing blades, and a fixed hole plate or die. These typical components are shown, for example, in U.S. Pat. No. 7,207,510 B2, issued Apr. 24, 2007, the disclosure of which is hereby incorporated by reference in its entirety. A threaded collar 22 attaches to the housing 20 to contain the grinder components therein. The collar 22 is removable from the housing for cleaning and for replacing/swapping components.

Whole or cubed raw meat is fed into the inlet 16 on top of the grinder head, and the meat is propelled horizontally on the rotating screw conveyor, which can also squash and partially mix the meat as it is propelled. At the end of the screw conveyor, the knife is positioned in front of and adjacent to the fixed hole plate. The screw conveyor forces the meat past the knife and through the plate. The rotating knife blades mince or grind the meat, which is discharged through the holes in the plate and through the outlet 18. The size of the holes in the plate determines the fineness of the ground meat.

During operation, the temperature inside the grinder head increases due to friction in the components and with the food products being processed. When grinding meat, this increased temperature inside the grinder head can cause the meat to heat up stick to the grinder components, which can slow down or block the grinding operation.

### SUMMARY

According to one aspect, an apparatus for grinding food products includes a housing including an inlet for receiving food products to be ground, an outlet for discharging the ground food product, and a grinding portion for housing components operable to grind the food product. The apparatus also includes a chamber for containing a coolant for cooling the grinding portion.

According to other aspects, the grinding portion can have a generally cylindrical configuration that the chamber is configured to follow. A cover can close the chamber and seals the coolant therein. The chamber can be an integral part of the housing. The coolant can comprise a cooling pack that is removable from the cooling chamber. The chamber can be a sealed chamber with the coolant disposed therein. The chamber can extend circumferentially up to 360 degrees around the grinding portion. The chamber can extend circumferentially about 215 degrees around the grinding portion. The chamber can extend circumferentially about 180 degrees around the grinding portion.

According to another aspect, a meat grinder housing comprises a chamber for storing a coolant for cooling the grinder housing. According to other aspects, the chamber can follow a cylindrical configuration of the housing. A cooling pack can be removable from the chamber. The chamber can be a sealed chamber. The chamber can extend circumferentially up to 360 degrees around the grinding portion. The chamber can extend circumferentially about 215 degrees around the grinding portion. The chamber can extend circumferentially about 180 degrees around the grinding portion.

### BRIEF DESCRIPTION OF THE DRAWINGS

For a better understanding of the invention, reference may be made to the accompanying drawings.

FIG. 1 is a side view of a prior art food processing apparatus including a grinder head.

FIGS. 2-3 are perspective views illustrating a grinder head according to an embodiment of the invention.

FIG. 4 is a rear view of the grinder head of FIGS. 2-3.

FIG. 5 is a side view of the grinder head of FIGS. 2-3.

FIG. 6 is a rear perspective view of the grinder head of FIGS. 2-3.

FIG. 7 is a partially exploded perspective view illustrating a grinder head according to a second embodiment of the invention.

FIG. 8 is a rear view illustrating the grinder head of FIG. 7.

### DESCRIPTION OF EMBODIMENTS

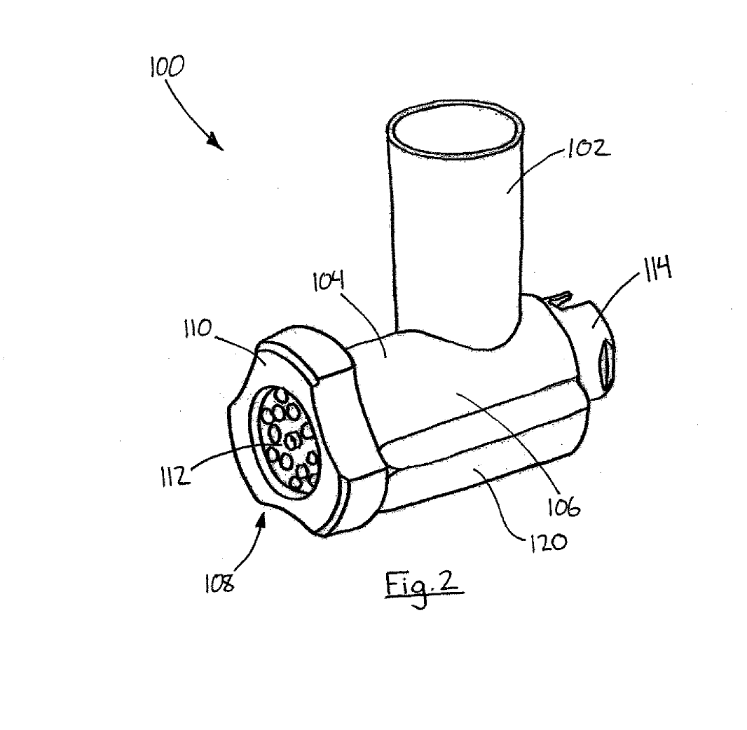

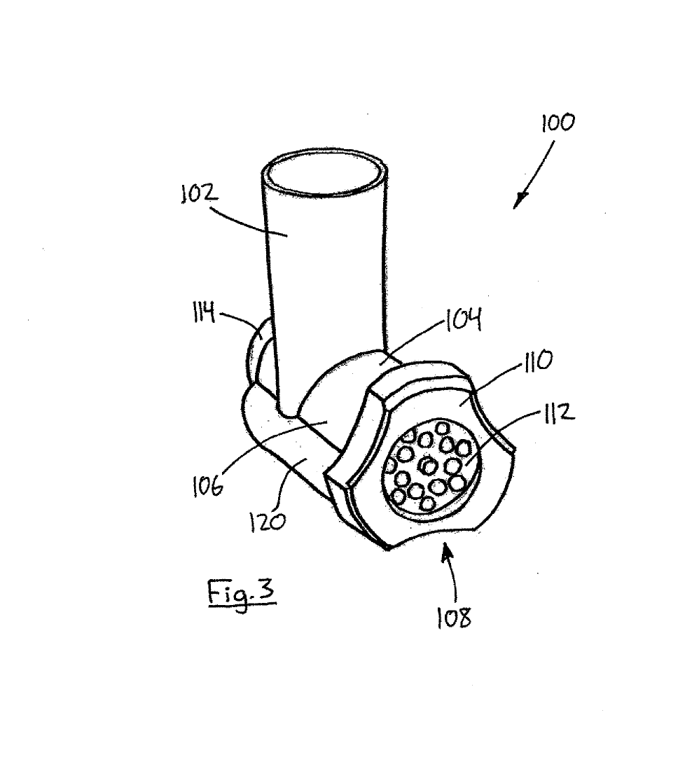

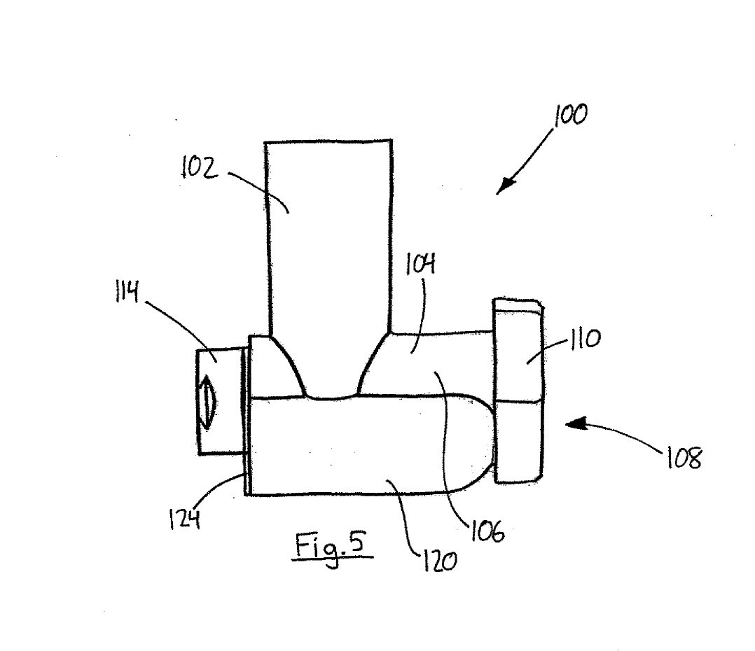

Referring to FIGS. 2-6, according to a first embodiment of the invention, an apparatus 100 in the form of a grinder head includes a portion 102, such as a chute or inlet, for receiving a food product, such as meat (e.g., beef, chicken or pork) or any other food product for which grinding is desired. The grinder head 100 also includes a housing 104 including a grinding portion 106 in which the food product, i.e., meat, is minced or ground to produce a ground meat product. The grinder head 100 further includes an outlet portion 108 through which the ground meat product is discharged.

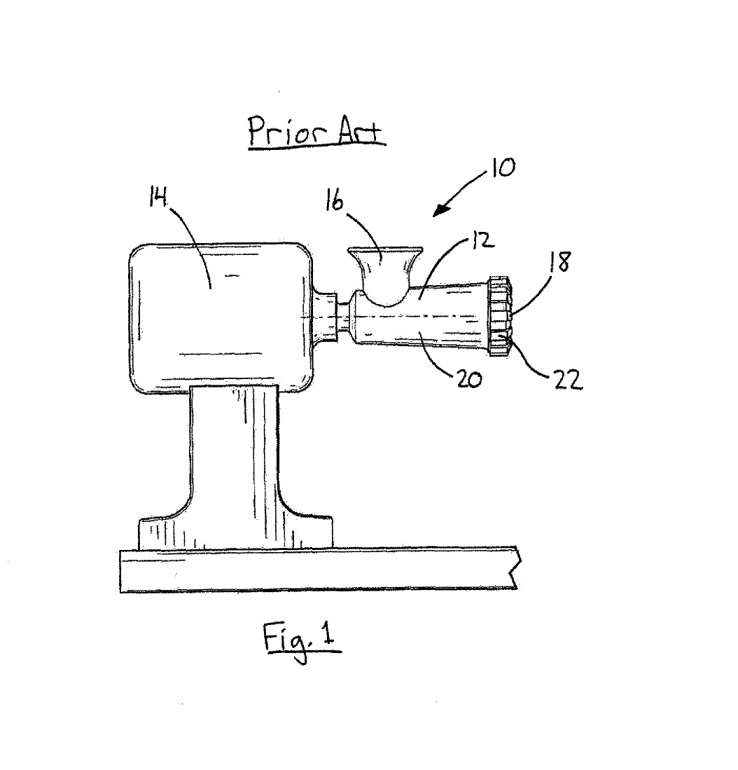

The grinder head 100 includes a coupling portion 114 that can be adapted for connection with a typical power unit (not shown in FIGS. 2-6), such as an electric motor (see, e.g., FIG. 1) or a hand crank unit. Operated by the power unit, the components in the grinding portion 106, e.g., the screw conveyor and the knife, rotate to move mix and grind the meat. A threaded collar 110 attached to the grinder housing 104 is removable so that the grinding portion 106 can be cleaned and so that the components can be removed for cleaning or so that the die plate 112 can be swapped or replaced.

According to the first embodiment, the grinder head 100 includes a cooling feature that counteracts heating due to friction between internal components. This helps prevent the meat from heating up as it is ground, which can cause the ground meat to stick to the grinder components and inhibit or halt the grinding process. The cooling feature can have a variety of configurations.

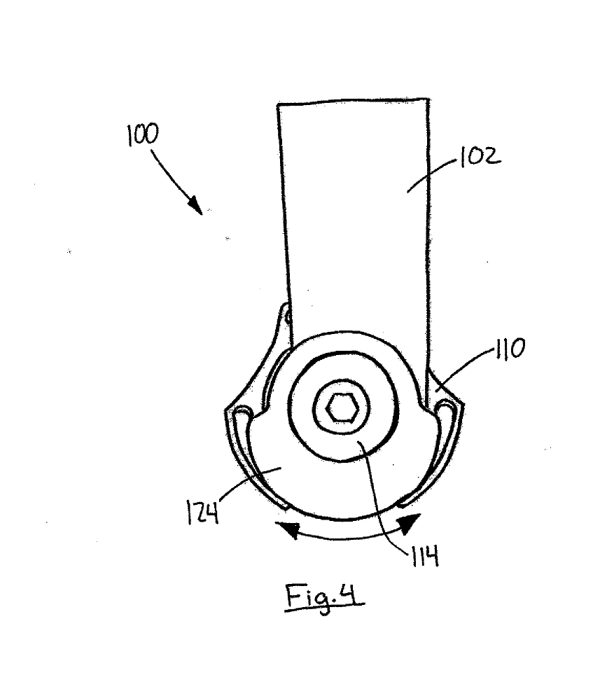

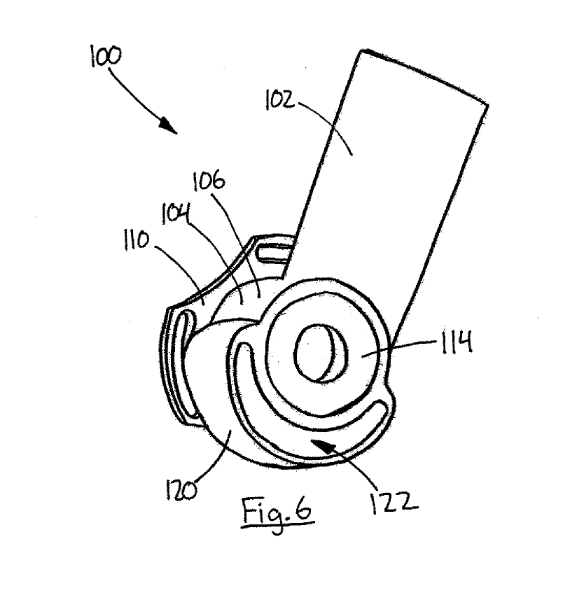

According to the invention, the housing 104 of the grinder head 100 includes a cooling chamber 120. As best shown in FIGS. 4 and 6, the cooling chamber 120 can extend along a substantial portion of the length of the grinding portion 106 of the housing 104 and can wrap circumferentially about the generally cylindrical grinding portion. In the embodiment of FIGS. 2-6, the cooling chamber 120 extends circumferentially around about half of, i.e., about 180 degrees around, the grinding portion 106. The extent to which the cooling chamber 120 extends circumferentially around the grinding portion 106 can vary, and can be greater or less than illustrated in FIGS. 2-6. For example, the cooling chamber 120 can extend circumferentially up to 360 degrees around the entire grinding portion 106.

The cooling chamber 120 defines an interior space or volume 122 that can be closed by a door or cover 124. As best shown in FIG. 4, the cover 124 can be configured to rotate or pivot in order to provide access to the volume 122 of the chamber 120, as indicated generally by the bi-directional arrow.

According to one embodiment, the volume 122 of the cooling chamber 120 can be filled with a coolant, such a liquid/gel-type substance commonly found in freezer chilled cooling packs. In this embodiment, chamber 120 can be closed with the cover 124 to seal the volume 122. To facilitate this seal, the grinder head 100 can include means, such as a gasket, and the cover can be secured to the housing 104 by means, such as machine screws. In this embodiment, prior to grinding, the grinder head 100 can be placed in a freezer, which chills and freezes the coolant.

In another embodiment, the chamber 120 can be filled with ice, which eliminates the need to periodically re-chill/refreeze the grinder head 100. In this embodiment, the volume 122 of the chamber 120 is filled with ice prior to use. When the ice melts, the water can be drained from the chamber 120 and the volume 122 can then be re-filled with ice for further use of the grinder head 100. In this embodiment, the chamber 120 and/or cover 124 could include a latching mechanism that permits manual opening/closing of the chamber. A suitable gasket/O-ring could be included to make this closure liquid tight. This would permit the user to pack the chamber 120 with ice as the coolant, and re-pack the chamber when the ice melts. In this embodiment, the chamber 120 could also be fit with a drain plug for draining melted ice. Additionally, a side or top mounted cover could also be used. This would allow for packing and re-packing ice on-the-go without dismounting the grinder head 100 from the power unit.

During use, the frozen coolant/ice helps to maintain the grinder head 100 at a low temperature. For example, the coolant can maintain the grinder head 100 at about 40° F. The advantage of a coolant/gel-filled chamber 120 is that the gel can be cooled below 32° F. The advantage of an ice-filled chamber 120 embodiment is the ability to prolong cooling without needing to stop for prolonged periods of re-cooling.

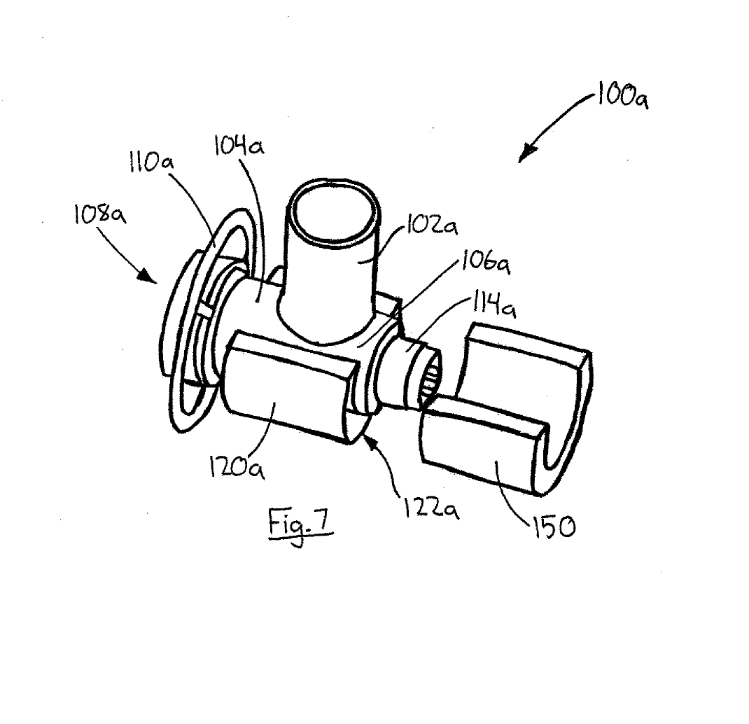

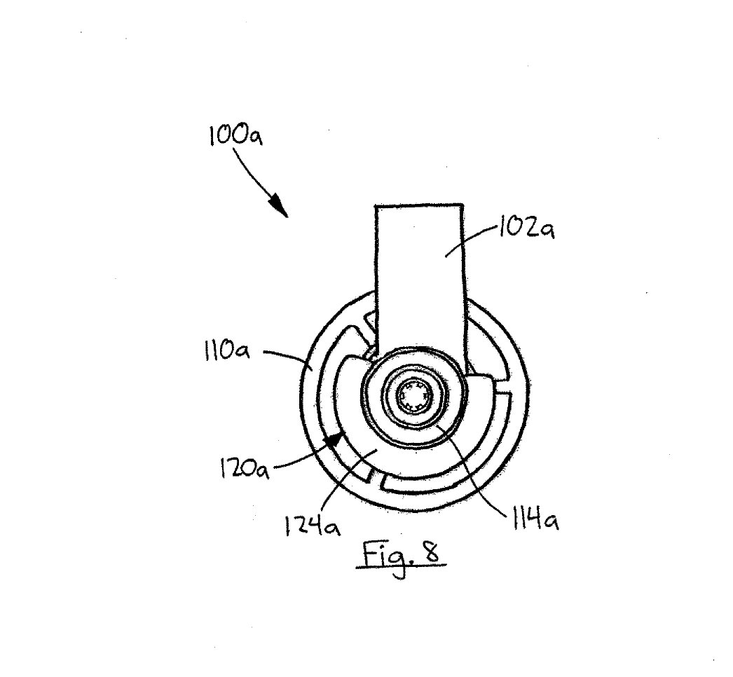

A second embodiment of the invention is illustrated in FIGS. 7-8. The embodiment of FIGS. 7-8 is similar to the embodiment of FIGS. 2-6. Because of this, FIGS. 7-8 utilize reference numbers that correspond to those used in FIGS. 2-6 to identify similar or identical elements. In FIGS. 7-8, these corresponding reference numbers include the suffix “a” in order to avoid confusion.

Referring to FIGS. 7-8, according to the second embodiment, an apparatus 100a in the form of a grinder head includes a portion 102a, such as a chute or inlet, for receiving a food product, such as meat (e.g., beef, chicken or pork) or any other food product for which grinding is desired. The grinder head 100a also includes a housing 104a including a grinding portion 106a in which the food product, i.e., meat, is minced or ground to produce a ground meat product. The grinder head 100a further includes an outlet portion 108a through which the ground meat product is discharged.

The grinder head 100a includes a coupling portion 114a that can be adapted for connection with a typical power unit (not shown in FIGS. 7-8), such as an electric motor (see, e.g., FIG. 1) or a hand crank unit. Operated by the power unit, the components in the grinding portion 106a, e.g., the screw conveyor and the knife, rotate to move mix and grind the meat. A threaded collar 110a attached to the grinder housing 104a is removable so that the grinding portion 106a can be cleaned and so that the components can be removed for cleaning or so that the die plate can be swapped or replaced.

According to the second embodiment, the grinder head 100a includes a cooling feature that counteracts heating due to friction between internal components. This helps prevent the meat from heating up as it is ground, which can cause the ground meat to stick to the grinder components and inhibit or halt the grinding process. The cooling feature can have a variety of configurations.

According to the invention, the housing 104a of the grinder head 100a includes a cooling chamber 120a. The cooling chamber 120a can extend along a substantial portion of the length of the grinding portion 106a of the housing 104a and can wrap circumferentially about the generally cylindrical grinding portion. In the embodiment of FIGS. 7-8, the cooling chamber 120 extends circumferentially around more than half of the grinding portion 106a. In this embodiment, the cooling chamber 120a extends circumferentially around about 215 degrees around of the grinding portion 106a. The extent to which the cooling chamber 120a extends circumferentially around the grinding portion 106a can vary, and can be greater or less than illustrated in FIGS. 7-8. For example, the cooling chamber 120a can extend circumferentially around the grinding portion 106a to the same extent as the chamber of the embodiment of FIGS. 2-6. Alternatively, the cooling chamber 120a can extend circumferentially up to 360 degrees around the entire grinding portion 106a.

The cooling chamber 120a defines an interior space or volume 122a that can be closed by a door or cover 124a. The cover 124a can be configured to rotate or pivot in order to provide access to the volume 122a of the chamber 120a.

According to the invention, the grinder head 100a can include a cooling pack 150 (see FIG. 7) that is configured to mate with and fit inside the volume 122a of the cooling chamber 120a. The cooling pack 150 can be configured and sized to occupy the entire volume 122a of the chamber 120a. Alternatively, the cooling pack 150 can be configured as a plurality of packs that in combination are configured and sized to occupy the volume 122a. For example, in a configuration where the chamber 120a extends circumferentially 360 degrees around the grinding portion 106a, the cooling pack 150 may comprise four packs, each of which extend about 90 degrees circumferentially around the grinding portion, or two packs, each of which extend about 180 degrees circumferentially around the grinding portion.

The cooling pack can be filled with a coolant, such a liquid/gel-type substance commonly found in freezer chilled cooling packs. These gel in the gel packs are primarily water-based and include a gel-forming substance, such as hydroxyethyl cellulose or a vinyl-coated silica gel. Other materials can be added to prevent bacterial growth. Advantageously, the substance in such gel packs can formulated to have a freezing point below that of water (32° F.) and therefore can enhance the cooling of the grinder head 100a.

In this embodiment, chamber 120a can be closed with the cover 124a to seal the volume 122a. Since the cooling pack 150 is itself a sealed enclosure, the need to seal the chamber 120a in this embodiment is reduced. If such a seal is necessary or desired, the grinder head 100a can include means, such as a gasket, and the cover can be secured to the housing 104a by means, such as machine screws.

Advantageously, in the embodiment of FIGS. 7-8, the grinder head 100a allows for the use of additional cooling packs 150, which can be held in standby while others are used in the grinder head. When the cooling packs 150 heat up during use and lose their effectiveness, they can be swapped with the frozen standby packs, thus eliminating the need to halt the grinding process for a prolonged period. As another advantage, in the embodiment of FIGS. 7-8, the grinder head 100a can be adapted for use with cubed or crushed ice in the event that the cooling packs 150 are spent or otherwise unavailable. In this instance, the volume 122a of the chamber 120a is filled with ice prior to use. When the ice melts, the water can be drained from the chamber 120a and the volume 122a can then be re-filled with ice for further use of the grinder head 100a.

During use, the cooling packs 150 help to maintain the grinder head 100a at a low temperature. For example, the coolant in the packs 150 can maintain the grinder head 100a at about 40° F. or less. The advantage of a coolant/gel-filled chamber 120a is that the gel can be formulated for cooling below 32° F.

While aspects of the present invention have been particularly shown and described with reference to the preferred embodiment above, it will be understood by those of ordinary skill in the art that various additional embodiments may be contemplated without departing from the spirit and scope of the present invention. Other aspects, objects, and advantages of the present invention can be obtained from a study of the drawings, the disclosure, and the appended claims.

Having described the invention, we claim:

1. An apparatus for grinding food products, comprising:
a housing including an inlet for receiving food products to be ground, an outlet for discharging the ground food product, and a grinding portion for housing components operable to grind the food product, and a chamber for containing a coolant for cooling the grinding portion.

2. The apparatus recited in claim 1, wherein the grinding portion has a generally cylindrical configuration that the chamber is configured to follow.

3. The apparatus recited in claim 1, further comprising a cover for closing the chamber and sealing the coolant therein.

4. The apparatus recited in claim 1, wherein the chamber is an integral part of the housing.

5. The apparatus recited in claim 1, wherein the coolant comprises a cooling pack that is removable from the cooling chamber.

6. The apparatus recited in claim 1, wherein the chamber is a sealed chamber with the coolant disposed therein.

7. The apparatus recited in claim 1, wherein the chamber extends circumferentially up to 360 degrees around the grinding portion.

8. The apparatus recited in claim 1, wherein the chamber extends circumferentially about 215 degrees around the grinding portion.

9. The apparatus recited in claim 1, wherein the chamber extends circumferentially about 180 degrees around the grinding portion.

10. A meat grinder housing comprising a chamber for storing a coolant for cooling the grinder housing.

11. The meat grinder housing recited in claim 10, wherein the chamber follows a cylindrical configuration of the housing.

12. The meat grinder housing recited in claim 10, further comprising a cooling pack that is removable from the chamber.

13. The meat grinder housing recited in claim 10, wherein the chamber is a sealed chamber.

14. The meat grinder housing recited in claim 10, wherein the chamber extends circumferentially up to 360 degrees around the grinding portion.

15. The meat grinder housing recited in claim 10, wherein the chamber extends circumferentially about 215 degrees around the grinding portion.

16. The meat grinder housing recited in claim 10, wherein the chamber extends circumferentially about 180 degrees around the grinding portion.
